(19) United States
(12) Patent Application Publication
(10) Pub. No.: US 2026/0119890 A1
(43) Pub. Date: Apr. 30, 2026

(54) METHOD AND SYSTEM FOR RETRIEVING API, AND METHOD AND SYSTEM FOR TRAINING API RETRIEVAL MODEL

(71) Applicant: SAMSUNG SDS CO., LTD., Seoul (KR)

(72) Inventors: Jae Sun SHIN, Seoul (KR); Dong Woo KIM, Seoul (KR); Hye Rim HONG, Seoul (KR); Joon Yi KIM, Seoul (KR); Min Young LEE, Seoul (KR)

(73) Assignee: SAMSUNG SDS CO., LTD., Seoul (KR)

(21) Appl. No.: 19/364,509

(22) Filed: Oct. 21, 2025

(30) Foreign Application Priority Data
Oct. 30, 2024 (KR) 10-2024-0151266

(51) Int. Cl. G06N 3/09; G06F 9/54; G06F 16/2453

(52) U.S. Cl. CPC G06N 3/09; G06F 9/541; G06F 16/24542

(57) ABSTRACT

A method and system for retrieving an Application Programming Interface (API) are provided. The method according to some embodiments may include obtaining a first query and inputting the first query to a pre-trained API retrieval model, and determining a retrieval target API corresponding to the first query from among a plurality of candidate APIs, based on an output from the API retrieval model, wherein the API retrieval model is trained using supervised learning with training data including a second query, an API set corresponding to the second query, and a sub-query corresponding to each of APIs included in the API set, wherein the sub-query is composed of a partial text included in the second query.

### CROSS-REFERENCE TO RELATED APPLICATION

This application claims priority from Korean Patent Application No. 10-2024-0151266 filed on Oct. 30, 2024, in the Korean Intellectual Property Office, and all the benefits accruing therefrom under 35 U.S.C. 119, the contents of which in its entirety are herein incorporated by reference.

### BACKGROUND

### Field

The present disclosure relates to an method and system for retrieving an Application Programming Interface (API), and a method and system for training an API retrieval model. Specifically, the present disclosure relates to a method for retrieving an API corresponding to a query in an information pool and a method for training an API retrieval model for the API retrieval method.

### Description of Related Art

An Application Programming Interface (API) is functionally subdivided unlike a passage (image, etc.), and thus a plurality of API may be required to perform/process one query.

In a method for retrieving an API corresponding to a query in an API pool using an API retrieval model, the query may be converted into a single sentence embedding vector, a similarity between the converted query embedding vector and an API embedding vector of the API may be calculated, and the API having a high similarity to the query may be extracted based on the calculated similarity.

However, in this case, the query is converted into one semantic vector. Thus, there is a problem in that a plurality of APIs having different features match the same query embedding vector. In other words, in order for two different APIs to be extracted in a corresponding manner to the query, a problem arises that although they have different features, both of respective API embedding vectors of the two APIs should have high similarity to the same query embedding vector.

The problem in which the plurality of API having different features match the same query embedding vector may be solved using a scheme in which a query is decomposed into a plurality of sub-queries using a large language model (LLM), and then one API corresponding to each of the sub-queries is extracted using the API retrieval model.

However, in this case, the LLM may perform the query decomposition based on an internal knowledge of the API without information on the API pool and without considering the similarity thereof with the API, such that reliability of the retrieval result may be lowered.

In addition, considering that the LLM is used for the API retrieval and that API retrieval is repeatedly performed on each sub-query, a lot of resources may be consumed in the API retrieval.

Accordingly, a new scheme for solving these problems in a method for retrieving the API corresponding to the query is required.

### SUMMARY

A technical purpose to be achieved using embodiments of the present disclosure is to provide a method for determining, from among a plurality of candidate Application Programming Interfaces (APIs), a retrieval target API corresponding to a query in consideration of a similarity of each of the plurality of candidate APIs with the query in performing multi-step retrieval, and a computing system for performing the method.

Another technical purpose to be achieved using embodiments of the present disclosure is to provide a method for determining a retrieval target multi-step corresponding to a query using an API retrieval model pre-trained using training data composed of a sub-query included in the query and an API corresponding to the sub-query in order to reduce resource consumption in performing the API retrieval, and a computing system for performing the method.

Still another technical purpose to be achieved using embodiments of the present disclosure is to provide a method for matching a candidate API with each of a plurality of tokens included in a query in order to prevent a problem in which respective API embedding vectors of a plurality of candidate APIs having different features match the same query embedding vector, and a computing system for performing the method.

The technical purposes to be achieved by the present disclosure are not limited to the technical purposes as mentioned above, and other technical purposes not mentioned may be clearly understood by those skilled in the art related to the present disclosure based on the following detailed descriptions.

According to an aspect of the present disclosure, there is provided a method for retrieving an application programming interface (API) performed by a computing system. The method may include obtaining a first query and inputting the first query to a pre-trained API retrieval model, and determining a retrieval target API corresponding to the first query from among a plurality of candidate APIs, based on an output from the API retrieval model, wherein the API retrieval model may be trained using supervised learning with training data including a second query, an API set corresponding to the second query, and a sub-query corresponding to each of APIs included in the API set, wherein the sub-query may be composed of a partial text included in the second query.

In some embodiments, wherein the first query may include a plurality of tokens, wherein the API retrieval model may include a first layer configured to calculate a similarity between a candidate API included in the plurality of candidate APIs and each of the plurality of tokens and a second layer configured to calculate a retrieval score of the candidate API related to the first query, based on the similarity.

In some embodiments, wherein the retrieval score of the candidate API may be a sum of respective weights of the candidate API respectively related to the plurality of tokens included in the first query, wherein a weight of the respective weights may be allocated based on the similarity.

In some embodiments, wherein the plurality of tokens may include a first token and a second token, wherein when a first similarity between the candidate API and the first token is higher than a second similarity between the candidate API and the second token, a first weight of the candidate API related to the first token may be higher than a second weight of the candidate API related to the second token.

According to another aspect of the present disclosure, there is provided a method for training an application programming interface (API) retrieval model performed by a computing system. The method may include obtaining a query to be learned, identifying a plurality of sub-queries included in the query, constructing training data including the query, the plurality of sub-queries, and an API corresponding to each of the plurality of sub-queries and training the API retrieval model using supervised learning with the training data.

In some embodiments, wherein the identifying of the plurality of sub-queries included in the query may include inputting the query into a large language model (LLM) and determining the API corresponding to each of the plurality of sub-queries, based on information output from the LLM.

In some embodiments, wherein the query may include a plurality of tokens, wherein the API retrieval model may include a first layer configured to calculate a similarity between the API and each of the plurality of tokens and a second layer configured to calculate a retrieval score of the API related to the query, based on the similarity.

In some embodiments, wherein the retrieval score of the API may be a sum of respective weights of the API respectively related to the plurality of tokens included in the query, wherein a weight of the respective weights may be allocated based on the similarity.

In some embodiments, wherein the plurality of tokens may include a first token and a second token, wherein when a first similarity between the API and the first token is higher than a second similarity between the API and the second token, a first weight of the API related to the first token may be higher than a second weight of the API related to the second token.

In some embodiments, wherein the training of the API retrieval model using supervised learning with the training data may include training the API retrieval model in a supervised manner to calculate the retrieval score of the API related to the query using a loss function, wherein the loss function may be predefined using a difference between the retrieval score of the API related to the query and a retrieval score of the API related to a sub-query corresponding to the API.

According to yet another aspect of the present disclosure, there is a system for retrieving an application programming interface (API). The system may include at least one processor and at least one memory storing instructions therein, wherein when the instructions are executed by the at least one processor, the instructions cause the at least one processor to obtain a first query and input the first query to a pre-trained API retrieval model, and determine a retrieval target API corresponding to the first query from among a plurality of candidate APIs, based on an output from the API retrieval model, wherein the API retrieval model my be trained using supervised learning with training data including a second query, an API set corresponding to the second query, and a sub-query corresponding to each of APIs included in the API set, wherein the sub-query may be composed of a partial text included in the second query.

According to yet another aspect of the present disclosure, there is a system for training an application programming interface (API) retrieval model. The system may include comprising at least one processor and at least one memory storing instructions therein, wherein when the instructions are executed by the at least one processor, the instructions cause the at least one processor to obtain a query to be learned, identify a plurality of sub-queries included in the query, construct training data including the query, the plurality of sub-queries, and an API corresponding to each of the plurality of sub-queries and train the API retrieval model using supervised learning with the training data.

According to yet another aspect of the present disclosure, there is a non-transitory computer-readable storage medium storing a computer program, which, when executed by at least one processor, causes the at least one processor to perform obtaining a first query and inputting the first query to a pre-trained application programming interface (API) retrieval model, and determine a retrieval target API corresponding to the first query from among a plurality of candidate APIs, based on an output from the API retrieval model, wherein the API retrieval model may be trained using supervised learning with training data including a second query, an API set corresponding to the second query, and a sub-query corresponding to each of APIs included in the API set, wherein the sub-query may be composed of a partial text included in the second query.

According to yet another aspect of the present disclosure, there is a non-transitory computer-readable storage medium storing a computer program, which, when executed by at least one processor, causes the at least one processor to perform obtaining a query to be learned, identifying a plurality of sub-queries included in the query, constructing training data including the query, the plurality of sub-queries, and an application programming interface (API) corresponding to each of the plurality of sub-queries and training the API retrieval model using supervised learning with the training data.

### BRIEF DESCRIPTION OF DRAWINGS

The above and other aspects and features of the present disclosure will become more apparent by describing in detail various embodiments thereof with reference to the attached drawings, in which:

FIG. 1 is a block diagram illustrating an example of a retrieval system to which an Application Programming Interface (API) retrieval system according to an embodiment of the present disclosure may be applied;

FIG. 2 is a flowchart illustrating an API retrieval method according to an embodiment of the present disclosure;

FIG. 3 is a flowchart illustrating an example of an overall operation for API retrieval of an API retrieval system according to some embodiments of the present disclosure;

FIG. 4 is a block diagram illustrating a configuration of an API retrieval model according to some embodiments of the present disclosure;

FIG. 5 is a diagram illustrating a method for calculating a retrieval score of a candidate API corresponding to a query according to some embodiments of the present disclosure;

FIG. 6 is a flowchart illustrating an API retrieval model training method according to an embodiment of the present disclosure;

FIG. 7 is a flowchart illustrating a specific example of an API retrieval model training method according to some embodiments of the present disclosure; and

FIG. 8 is a block diagram illustrating an example of a computing device for performing some embodiments of the present disclosure.

### DETAILED DESCRIPTIONS

Hereinafter, example embodiments of the present disclosure will be described with reference to the attached drawings. Advantages and features of the present disclosure and methods of accomplishing the same may be understood more readily by reference to the following detailed description of example embodiments and the accompanying drawings. The present disclosure may, however, be embodied in many different forms and should not be construed as being limited to the embodiments set forth herein. Rather, these embodiments are provided so that this disclosure will be thorough and complete and will fully convey the concept of the disclosure to those skilled in the art, and the present disclosure will only be defined by the appended claims.

In describing this disclosure, specific descriptions of relevant disclosed configurations or features are omitted where it is believed that such detailed descriptions would obscure the essence of the invention.

Unless otherwise defined, all terms used in the present specification (including technical and scientific terms) may be used in a sense that may be commonly understood by those skilled in the art. In addition, the terms defined in the commonly used dictionaries are not ideally or excessively interpreted unless they are specifically defined clearly. The terminology used herein is for the purpose of describing particular embodiments only and is not intended to be limiting of the disclosure.

In this specification, the singular also includes the plural unless specifically stated otherwise in the phrase.

In addition, in describing the component of the present disclosure, terms, such as first, second, A, B, (a), (b), may be used. These terms are only for distinguishing the components from other components, and the nature or order of the components is not limited by the terms.

In the following embodiments, components described with reference to terms such as “part,” “unit,” “module,” “block,” or other similar terms used in the following descriptions and depicted as functional blocks in the accompanying drawings can be implemented as software, hardware, or a combination thereof. The software may include, for example, machine code, firmware, embedded code, and application software. Additionally, the hardware may include, for example, electrical circuits, electronic circuits, processors, computers, integrated circuits, integrated circuit cores, passive elements, or combinations thereof.

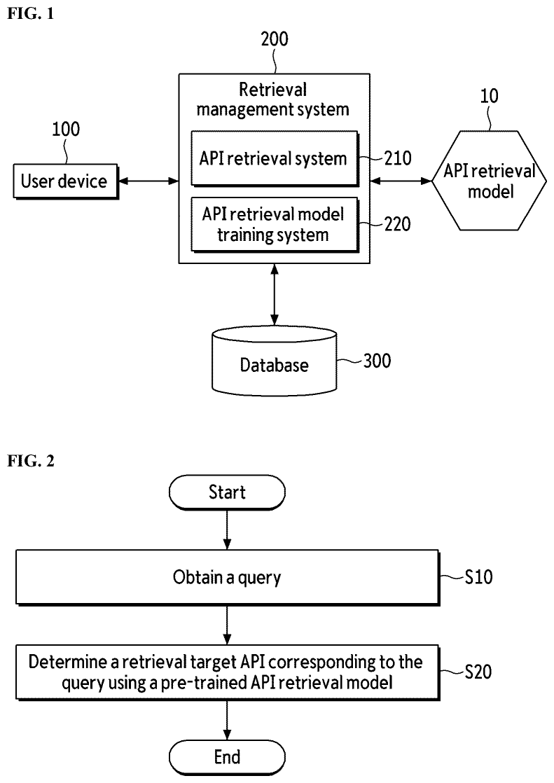

FIG. 1 is a block diagram illustrating an example of a retrieval system to which an Application Programming Interface (API) retrieval system according to an embodiment of the present disclosure may be applied.

The retrieval system of FIG. 1 may provide a framework for performing methods and/or operations according to some embodiments of the present disclosure. For example, the retrieval system may provide a framework for retrieving a retrieval target API corresponding to a query input from a user in an information pool including a plurality of application programming interfaces (APIs), and providing the retrieved retrieval target API to the user.

Referring to FIG. 1, the retrieval system may include a user device 100, a retrieval management system 200, an API retrieval model 10, and/or database 300.

The user device 100 may include each of various devices used by the user to transmit and receive various data and/or information to and from another device via communicating therewith.

In the present disclosure, the user may refer to a person who inputs the query as an API retrieval target according to some embodiments of the present disclosure.

The user device 100 may include a smartphone, a tablet PC, a laptop, or the like, but is not limited thereto. For example, the user device 100 may include each of various computing devices including a wireless communication means and/or a computing means. The user device 100 may be referred to as a user terminal, a wireless device, a mobile terminal, a portable device, or the like.

The user device 100 may be used to use the retrieval management system 200 according to embodiments of the present disclosure. For example, the user device 100 may transmit a query of a request input from the user to the retrieval management system 200. In another example, the user device 100 may display a user interface for an application in which a function of the retrieval management system 200 is implemented.

In the present disclosure, the query may be an API retrieval target and be referred to as a request, etc.

The retrieval management system 200 may perform API retrieval by performing methods and/or operations according to some embodiments of the present disclosure using the multi-step retrieval model 10 and/or the database 300.

In the present disclosure, the multi-step retrieval may mean determining a plurality of candidate APIs corresponding to the query from among a plurality of candidate APIs as a retrieval target API.

The retrieval management system 200 may include an API retrieval system 210 for performing the multi-step retrieval, and/or an API retrieval model training system 220 for training the API retrieval model 10.

The API retrieval system 210 may obtain a query and determine a retrieval target API corresponding to the query from among a plurality of candidate APIs using the API retrieval model 10. In addition, the API retrieval system 210 may transmit the retrieval target API corresponding to the query as determined according to some embodiments of the present disclosure to the user device 100.

The API retrieval system 210 may input the query to the API retrieval model 10 and determine one or more retrieval target APIs corresponding to the query from among the plurality of candidate APIs based on the output of the API retrieval model 10.

The API retrieval model 10 may be a model pre-trained to calculate a similarity between the input query and a candidate API.

In this case, each of the query and the candidate API may be data formed in the form of an embedding vector. The API retrieval model 10 may be a model pre-trained to calculate a vector similarity between a token embedding vector of each of a plurality of tokens included in the input query and an API embedding vector of the candidate API.

In addition, the API retrieval model 10 may be a model pre-trained to calculate a retrieval score of the candidate API related to the input query. The retrieval score is a value that is a criterion for determining some of the plurality of candidate APIs as a retrieval target API corresponding to the query, and may be a criterion for determining a retrieval priority of the candidate API.

For example, according to some embodiments of the present disclosure, a candidate API having the highest retrieval priority (i.e., having the highest retrieval score) may be determined as a retrieval target API corresponding to the query.

In addition, the API retrieval model 10 may calculate a retrieval score of each of the plurality of candidate APIs based on the query and output the calculated retrieval score and/or information (e.g., API name, retrieval priority, etc.) about the candidate API corresponding to the calculated retrieval score.

The API retrieval model training system 220 may train the API retrieval model 10 by performing steps and/or operations according to some embodiments of the present disclosure. The API retrieval system 210 may perform the API retrieval using the API retrieval model 10 pre-trained by the API retrieval model training system 220.

The API retrieval model training system 220 may obtain a query to be learned and identify a plurality of sub-queries included in the query. In addition, the API retrieval model training system 220 may construct training data including the query, a plurality of queries, and/or an API corresponding to each of the plurality of queries, and may perform supervised learning on the API retrieval model 10 using the training data.

The database 300 may refer to storage including various types of information/data therein. For example, the database 300 may include an information database (DB) including a plurality of candidate APIs, the training data constructed according to some embodiments of the present disclosure, etc.

The database 300 may include one or more Artificial Intelligence (AI)-based models according to some embodiments of the present disclosure.

For example, the database 300 may include a query embedding model pre-trained to generate an embedding vector of a query in a form of a natural language.

The retrieval management system 200 may perform steps/operations for obtaining an embedding vector of a query and/or an embedding vector of a candidate API according to some embodiments of the present disclosure using one or more models included in the database 300 (e.g., a query embedding model, an API embedding model, etc.).

In another example, the database 300 may include an API embedding model pre-trained to generate the embedding vector of the candidate API. In still another example, the database 300 may include a Large Language Model (LLM).

The retrieval management system 200 may perform a step/operation for acquiring the training data for training the API retrieval model 10 according to some embodiments of the present disclosure using the LLM.

The retrieval management system 200 may be implemented on at least one computing device. For example, all functions of the retrieval management system 200 may be implemented on one computing device. In another example, some functions of the retrieval management system 200 may be implemented on a first computing device, and the remaining functions may be implemented on a second computing device. Further, specific functions of the retrieval management system 200 may be implemented on one or more computing devices.

The components illustrated in FIG. 1 may communicate each other over various types of wired/wireless networks. The device and/or system according to the present disclosure may be applicable to a Local Area Network (LAN), a Wide Area Network (WAN), a mobile radio communication network, a wireless broadband internet (Wibro), and the like. However, the present disclosure is not limited thereto. The device and/or system according to the present disclosure may be applicable to any other communication system.

Hereinafter, embodiments in which the computing system performs the API retrieval according to embodiments of the present disclosure will be described in detail with reference to FIGS. 2 to 5.

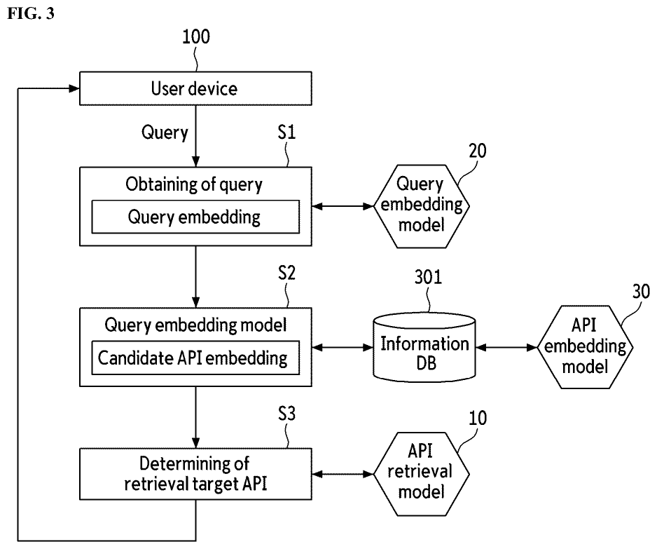

For reference, FIGS. 2 to 3 illustrate steps/operations performed in the retrieval system and/or the API retrieval system 210. Accordingly, in the following description, when a subject of a specific step/operation is omitted, the step/operation may be understood as being performed in the retrieval system and/or the API retrieval system 210.

In addition, it should be noted that the technical idea that may be understood from the embodiments as described with reference to FIGS. 2 to 5 may be obviously applied to the computing system according to the embodiments described with reference to FIG. 1, unless otherwise specified.

FIG. 2 is a flowchart illustrating an API retrieval method according to an embodiment of the present disclosure.

Referring to FIG. 2, a query as an API retrieval target may be obtained in S10.

The query is input to the pre-trained API retrieval model 10, and one or more retrieval target API corresponding to the query may be determined from among a plurality of candidate APIs based on the output of the API retrieval model 10 in S20. In this regard, the query and/or the candidate API may be formed in the form of an embedding vector.

In S20, the retrieval target API may be automatically determined based on the output of the API retrieval model 10 in response to the input of the query thereto.

The API retrieval model 10, as described with reference to FIG. 1, may be a model pre-trained to calculate a similarity between a query and a candidate API and/or a retrieval score of the candidate API based on the query.

The API retrieval model 10 may be trained using supervised learning with the training data including the query to be learned which is distinguished from a query as the API retrieval target in S10, an API set corresponding to the query to be learned or a learning target query, and a sub-query corresponding to each of the APIs included in the API set.

In this case, the sub-query may be composed of a partial text included in the learning target query.

According to some embodiments of the present disclosure, the training is performed using the training data including the sub-queries into which the query is divided, and an API corresponding to the sub-query in the training step of the API retrieval model 10, such that the APIs corresponding to the query may be retrieved even when the query as the API retrieval target is not divided in an inference step of the API retrieval model 10.

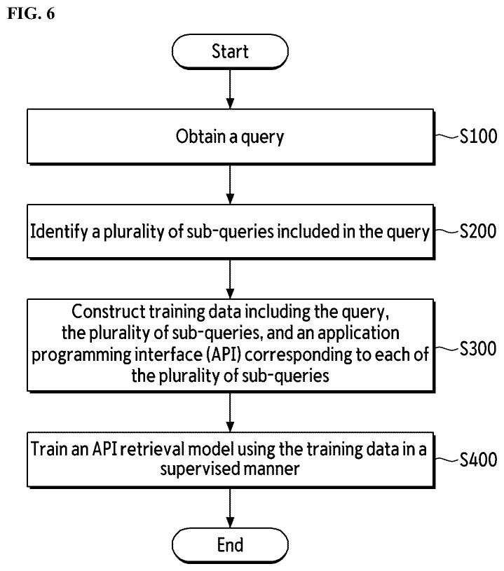

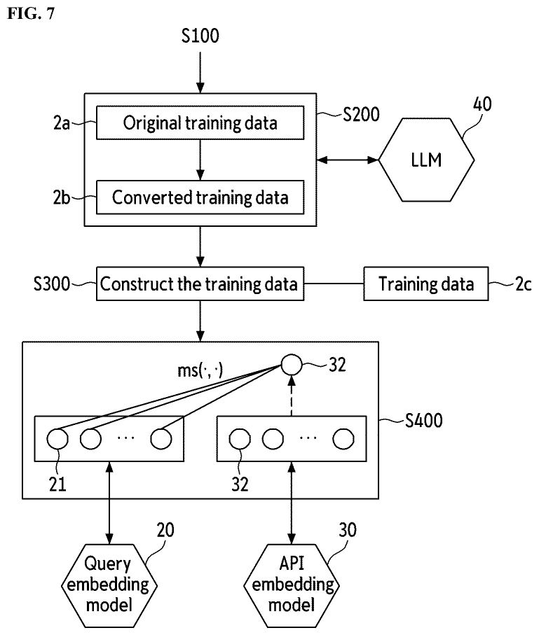

A detailed embodiment related to the training method for the API retrieval model 10 will be described later with reference to FIGS. 6 to 7.

The API retrieval model 10 calculates a retrieval score of each of a plurality of candidate APIs based on the input query according to some embodiments of the present disclosure.

According to some embodiments of the present disclosure, when the candidate API satisfies a predetermined criterion for determining the retrieval target API, the API retrieval model 10 may output the calculated similarity between the query and the candidate API, and/or information on the candidate API (e.g., API name, retrieval score, retrieval priority, etc.).

In S20, a preset number of the retrieval target APIs may be determined from among the plurality of candidate APIs.

For example, when, in S20, the preset number is k (k is 1 or larger), the retrieval priority is determined in the order of the highest retrieval score based on the query. Thus, k candidate APIs having the highest retrieval priority among the plurality of candidate APIs may be determined as the retrieval target API.

Next, detailed embodiments of a process in which the API retrieval system 210 determines the retrieval target API corresponding to the query by performing the steps/operations described with reference to FIG. 2 will be described with reference to FIG. 3.

FIG. 3 is a flowchart illustrating an example of an overall operation for API retrieval of the API retrieval system 210 according to some embodiments of the present disclosure.

Referring to FIG. 3, the API retrieval system 210 may obtain the query based on which the API is retrieved in S1, obtain a plurality of candidate APIs in S2, and determine a retrieval target API corresponding to the query from among the plurality of candidate APIs in S3.

In S1, the query formed in the form of the embedding vector may be obtained.

For example, in S1, the API retrieval system 210 may receive a query in a natural language form from the user device 100, and may generate a query embedding vector of the query using the query embedding model 20.

In S1, the obtained query embedding vector may include a token embedding vector corresponding to each of a plurality of tokens included in the query.

For example, in S1, when the query in the form of a natural language is input, a token embedding vector of each of a plurality of tokens included in the query may be generated using the query embedding model 20. The API retrieval system 210 may tokenize the query received from the user device 100, and may generate a plurality of token embedding vectors using the query embedding model 20.

In S2 to S3, the API retrieval system 210 may retrieve a retrieval target API corresponding to the query from the information DB 301 including a plurality of candidate APIs related to the query using the API retrieval model 10.

In S2, a candidate API formed in the form of an embedding vector may be obtained.

For example, in S2, the API retrieval system 210 may obtain an API embedding vector of the candidate API generated by an API embedding model 30 from the information DB 301.

In another example, in S2, the API retrieval system 210 may obtain various types of information (i.e., candidate API) from the information DB 301, and generate an API embedding vector of the obtained candidate API using the API embedding model 30.

In S3, the API retrieval system 210 may input the query to the API retrieval model 10, and automatically determine the retrieval target API corresponding to the query from among the plurality of candidate APIs included in the information DB 301, based on an output of the API retrieval model 10 in response to the input of the query thereto.

In S3, the retrieval target API may be determined based on a retrieval score of the candidate API corresponding to the query from among the plurality of candidate APIs.

In S3, the query input to the API retrieval model 10 may refer to a query (i.e., a query embedding vector) formed in the form of the embedding vector obtained in S1.

For reference, in the present disclosure, the information DB 301 may be referred to as an information pool.

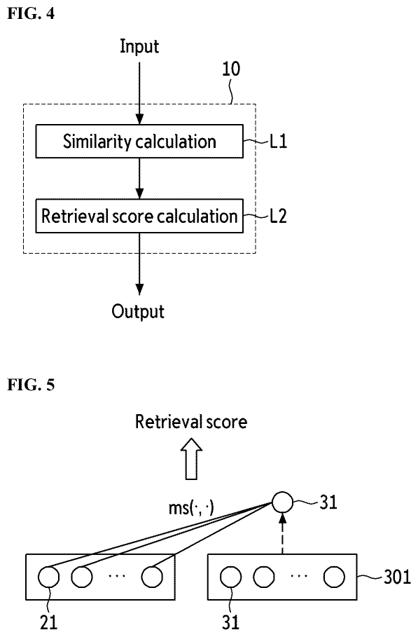

Next, embodiments related to a method for calculating a retrieval score of a candidate API corresponding to a query together with a configuration of the API retrieval model 10 will be described in detail with reference to FIG. 4.

FIG. 4 is a block diagram illustrating a configuration of the API retrieval model 10 according to some embodiments of the present disclosure.

Referring to FIG. 4, the API retrieval model 10 may receive the query, calculate a retrieval score of each of a plurality of candidate APIs based on the input query, and output the calculated retrieval score and/or information (e.g., API name, retrieval priority, etc.) about the candidate API corresponding to the calculated retrieval score.

The API retrieval model 10 may include a similarity calculation layer L1 for calculating a similarity between the candidate API included in the plurality of candidate APIs and each of the plurality of tokens included in the query based on which the retrieval is performed. In this regard, each of the plurality of tokens included in the query may be formed in a form of an embedding vector.

In the similarity calculation layer L1, the similarity between the candidate API and the query may be calculated by matching the candidate API with each of the tokens included in the query. That is, the similarity between the token embedding vector of each of the plurality of tokens included in the query and the API embedding vector of the candidate API may be calculated in the similarity calculation layer L1.

In this regard, the similarity between the candidate API and the token included in the query means a similarity between vectors and may be a cosine similarity. However, this is an example. The present disclosure is not limited thereto. For example, the similarity may be a cosine similarity, a Euclidean distance, a jaccard similarity, a levenshtein distance, or the like.

In addition, the API retrieval model 10 may further include a retrieval score calculation layer L2 for calculating a retrieval score of the candidate API related to the query, based on the similarity between the candidate API and each of the tokens included in the query.

In the retrieval score calculation layer L2, a retrieval score that is a criterion for determining the retrieval priority of the candidate API may be calculated as a sum of weights of the candidate API respectively related to the plurality of tokens included in the query.

In the retrieval score calculation layer L2, the weight of the candidate API related to each token may be allocated based on the similarity between the candidate API and each of the tokens included in the query.

For example, the weight of the candidate API related to each token may be assigned a higher value than the weight of another candidate API as the similarity between the candidate API and each token is higher than that between another candidate API and each token.

Hereinafter, a method for calculating the similarity between the candidate API and the token included in the query and/or the retrieval score of the candidate API based on the query in the similarity calculation layer L1 and the retrieval score calculation layer L2 will be described in detail with reference to FIG. 5.

FIG. 5 is a diagram illustrating a method for calculating a retrieval score of a candidate API corresponding to a query according to some embodiments of the present disclosure.

In the similarity calculation layer L1, the similarity between one candidate API and one query may be calculated based on a similarity between each of the plurality of tokens included in the query and one candidate API as calculated by matching one candidate API with each of the plurality of tokens included in the query.

When a matching signal ms(⋅,⋅) means a signal indicating a similarity between one API and one query, an API embedding vector is v, a token index indicating each of the tokens included in the query is i, and a token embedding vector of each token is q[i], the matching signal may be defined as follows using a similarity (q[i], v) between the API and each token.

$$ms : OM ( T ) \times {ℝ}^{dim ( T )} \to {ℝ}^{∞} , ( q , v ) ↦ m s ( q , v ) ,$$

$$where ms ( q , v ) [ i ] = \{ \begin{matrix}similarity ( q [ i ] , v ) & for i ∈ {ℤ}_{[ 1 , l e n ( q ) ]} , \\ 0 & for i > le n ( q )\end{matrix} ,$$

T may mean a vector space of a token, OM(T) may mean an ordered multi-set of T for a token set [symbol] , and [symbol] NSV represents an API embedding vector. In addition, len(q) denotes the number of tokens included in the query.

As illustrated in FIG. 5, a token embedding vector of each of the tokens 21 included in the query and an API embedding vector of one candidate API 31 among a plurality of candidate APIs included in the information DB match each other to generate the matching signal, and thus a plurality of matching signals corresponding to one candidate API may be generated.

In the retrieval score calculation layer L2, a weight is allocated to each of a plurality of matching signals generated in a corresponding manner to one candidate API 31 in order to calculate a retrieval score of one candidate API 31 based on the query. As illustrated in FIG. 5, the retrieval score may be calculated based on a sum of respective weights of the matching signals.

In the present disclosure, the weight w(⋅,⋅) is a value allocated to the candidate API related to each of the tokens included in one query to calculate the retrieval score of one candidate API related to one query, and means a value allocated to each of the plurality of matching signals generated in a corresponding manner to one candidate API.

When a single query w(⋅,⋅) is q, and a token index indicating each of the tokens included in the query is i, the weight w(w) may be defined as follows using a rectified linear unit (relu) function and a predefined weight scale function ws(⋅,⋅).

$$w : OM ( T ) \times {ℤ}_{\geq 1} \to ℝ ,$$

$$( q , i ) ↦ 2 \cdot ( σ ( w s ( q , i ) * rel u ( W P [ i ] ) ) - 0 \text{.5} ) ( σ : sigmoid )$$

WP denotes a learnable vector having a specific dimension, and WP[i] denotes an i-th component of the learnable vector having the specific dimension. For example, WP may be the learnable vector of a base model having 512 dimensions.

In the above definition, 2 and/or 0.5 is an example of a value for adjusting the scale of the weight value. The present disclosure is not necessarily limited thereto.

According to some embodiments of the present disclosure, a retrieval score of one candidate API related to one query may be calculated as a sum of respective weights of the candidate API respectively related to the tokens included in one query.

In this case, in order to determine the candidate API having a high similarity to the query as the retrieval target API, it is necessary to allocate a higher weight to the token as the similarity of the token among the plurality of tokens included in the query to the candidate API is higher.

When the retrieval score of the API is calculated without considering a form of the matching signal (i.e., the similarity of the matching signal), the retrieval priority of the API may be determined as a lower priority due to a low retrieval score even though the API has a high similarity to the query.

In other words, when a weight is allocated to each of the plurality of matching signals generated in a corresponding manner to one candidate API, a higher weight value should be allocated to a higher matching signal (i.e., having a high similarity) among the plurality of matching signals.

In the retrieval score calculation layer L2, the plurality of matching signals generated in a corresponding manner to one candidate API may be arranged in a descending from a higher similarity to a lower similarity, and the weight allocated to the matching signals in the arranged order may be deceased.

When the matching signals ms(q, v)[i] generated corresponding to one candidate API are arranged in the descending order from a higher similarity to a lower similarity, the plurality of matching signals generated in a corresponding manner to the candidate API may be arranged in an order in which the similarity value decreases as the index i increases.

A weight scale function ws(⋅,⋅) may refer to a function for allocating the weight to each matching signal so that the weight decreases as the index i indicating each of the arranged matching signals ms(q, v)[i] increases and may be defined as follows.

$$ws : OM ( T ) \times {ℤ}_{\geq 1} \to ℝ , ( q , i ) ↦ 1 - \frac{i}{l e n ( q )}$$

However, this is an example of the weight scale function, and the present disclosure is not limited thereto.

For example, the weight scale function may be defined in various forms formed to assign the weight to each of the arranged matching signals so as to satisfy w(q, v)[i]≥w(q, v)[j](i<j).

In other words, the weight scale function may be defined as various types of functions as long as a condition under which a value of ws(q, i) decreases as the index i indicating the matching signal increases, and a condition under which ws(q, i)=0 for i≥len(q) (q∈OM(T)) when the query q is given are satisfied.

In the retrieval score calculation layer L2, a score function s(⋅,⋅) for calculating a retrieval score of one candidate API related to one query may be defined using the matching signal related to each token and the weight function as follows.

$$s : OM ( T ) \times {ℝ}^{dim ( T )} \to ℝ , ( q , v ) ↦ {\sum }_{i = 1}^{l e n ( q )} w ( q , i ) * SORT ( m s ( q , v ) ) [ i ]$$

SORT(⋅) may mean an arrangement function of arranging the matching signals in the descending order.

According to some embodiments of the present disclosure, in performing the API retrieval, the API may match each of the tokens included in the query such that a plurality of APIs having different features may match different signals. Thus, a problem of the performance degradation of the API retrieval model 10 occurring as the plurality of APIs matches the same one query may be prevented.

For reference, the embodiments described with reference to FIG. 5 are described on the assumption that one query that is not divided into a plurality of sub-queries is input to the API retrieval model 10. However, the present disclosure is not limited thereto. That is, when a sub-query according to some embodiments of the present disclosure is input to the API retrieval model 10, the API retrieval model 10 may calculate the similarity between each of the tokens included in the sub-query input thereto as one input query and the API and/or the retrieval score of the API based on the sub-query, according to the embodiments described with reference to FIG. 5.

Hereinafter, embodiments in which the computing system trains the API retrieval model 10 according to embodiments of the present disclosure will be described in detail with reference to FIGS. 6 to 7.

The API retrieval model 10 trained using supervised learning according to the embodiments described with reference to FIGS. 6 to 7 may correspond to the API retrieval model 10 described with reference to FIG. 1.

In addition, unless otherwise specified, the API retrieval model 10 trained using supervised learning according to the embodiments as described with reference to FIGS. 6 to 7 may correspond to the API retrieval model 10 according to the embodiments as described with reference to FIGS. 2 to 5.

For reference, FIGS. 6 to 7 illustrate steps/operations performed in the retrieval system and/or the API retrieval model training system 220. Accordingly, in the following description, when a subject of a specific step/operation is omitted, the step/operation may be understood as being performed by the retrieval system and/or the API retrieval model training system 220.

In addition, it should be noted that the technical idea that may be understood from the embodiments as described with reference to FIGS. 6 to 7 may be obviously applied to the computing system according to the embodiments as described with reference to FIG. 1, unless otherwise specified.

FIG. 6 is a flowchart illustrating an API retrieval model training method according to an embodiment of the present disclosure.

Referring to FIG. 6, the query to be leaned may be obtained in S100, and a plurality of sub-queries included in the query may be identified in S200.

In S200, the sub-query may be composed of a partial text included in the query to be learned.

The training data including the query, a plurality of sub-queries, and the API corresponding to each of the plurality of sub-queries may be constructed in S300, and the API retrieval model 10 may be trained using supervised learning with the training data in S400.

In S400, the API retrieval model 10 may be trained using supervised learning on a training data set including a plurality of pieces of training data different from each other.

For example, in S400, the query included in the training data may be input to the API retrieval model 10, and the API retrieval model 10 may be trained in the supervised manner so as to calculate the similarity between the input query and the API and/or a retrieval score of the API based on the input query.

In S400, as described with reference to FIG. 4, the API retrieval model 10 subjected to the supervised learning may include the similarity calculation layer L1 for calculating the similarity between the API and each of a plurality of tokens included in the query to be learned.

In addition, as described with reference to FIG. 4, the API retrieval model 10 may further include the retrieval score calculation layer L2 for calculating the retrieval score of the API related to the query, based on the similarity between the API and each of the tokens included in the query to be learned.

In S200, the performance of the API retrieval model 10 may be improved by updating the parameter included in the layers L1 and L2 of the API retrieval model 10 and/or the weight of the API retrieval model 10 using the training data.

Next, a specific embodiment for performing, by the API retrieval model training system 220, the steps/operations according to S200 to S400 of FIG. 6 will be described with reference to FIG. 7.

FIG. 7 is a flowchart illustrating a specific example of an API retrieval model training method according to some embodiments of the present disclosure.

S100 to S400 of FIG. 7 may correspond to S100 to S400 of FIG. 6.

Referring to FIG. 7, in S200, a Large Language Model (LLM) 40 may be used to identify a plurality of sub-queries included in a query to be learned.

In S200, the API retrieval model training system 220 may input the query to the LLM 40, identify a plurality of sub-queries included in the query using information output from the input LLM 40, and determine an API corresponding to each of the plurality of sub-queries.

Specifically, in S200, the API retrieval model training system 220 may convert original training data 2a using the LLM 40 to generate converted training data 2b.

The original training data 2a may be composed of one query and a plurality of API related to one query. The converted training data 2b may be composed of a plurality of sub-queries included in one query, and an API corresponding to each of the plurality of sub-queries.

For example, when the original training data 2a is composed of {query (Q), API #1, API #2, . . . , API #N}, the converted training data 2b may be composed of [{a sub-query #1 of Q, API #1}, {a sub-query #2 of Q, API #2}, . . . , {a sub-query #N of Q, API #N}].

In S200, the API retrieval model training system 220 may input the original training data 2a and a prompt to the LLM 10, and may obtain the converted training data 2b using information output from the LLM 10. For example, the API retrieval model training system 220 may input, to the LLM 10, the prompt including an example for identifying a plurality of sub-queries included in the query of the original training data 2a.

For example, in S200, as shown in a following table, the prompt including examples composed of [query], [APIs related to the query], {sub-query included in the query, and API corresponding to the sub-query} may be input to the LLM 40.

TABLE 1
Given a [Query] and an [API], your task is to extract the sub-queries within the [Query]
corresponding to the [API]. You must generate sub-queries corresponding to the APIs in order.
Here are some examples.
[Query]
I'm concerned about the COVID-19 situation in India and I want to stay informed. Can you give
me the latest updates on COVID-19? I also want to know the guidelines, bills, and any other
important information related to the pandemic.
[API]
1. API name is Get Info, and its description is Get Covid Latest Information
2. API name is Get Latest Updates, and its description is Coronavirus India Live Guidelines, Bills,
etc
[Sub-query]
{“name”: ‘Get Info’, “query”: ‘Can you give me the latest updates on COVID-19?’}
{“name”: ‘Get Latest Updates’, “query”: ‘I also want to know the guidelines, bills, and any other
important information related to the pandemic.’}
[Query]
My friends and I are avid tennis fans and we want to know the rankings of the top 50 ATP singles
players. Could you provide us with the player names, ranks, and points for the current season?
[API]
1. API name is Live Players Rankings, and its description is With this endpoint, you can retrieve
info about the live tennis rankings for a given number of players, with position/points/info about
the last match played in the current active tournament. Please note that in the ATP circuit the
official leaderboard is updated every Monday.
2. API name is Official ATP Players Rankings, and its description is This endpoint allows you to
retrieve the rankings(**singles**+ **doubles**) of the current tennis season. You can arbitrarily
decide the number of players displayed (nplayers) and the time window to refer to (timestamp).
For example, if nplayers = 10, category= ‘singles’ and timestamp = 2022-04-11 you will receive
the top 10 singles standings at the corresponding timestamp (**IMPORTANT**: The timestamp
must be in the following format **YYYY-MM-DD** and the date **must fall on Monday**
since the rankings are updated at the start of every week)
[Sub-query]
{“name”: ‘Live Players Rankings’, “query”: ‘Could you provide us the ranks for the current
season?’}
{“name”: ‘Official ATP Players Rankings’, “query”: ‘Could you provide us with the player names,
and points for the current season?’}
(...)

In S300, the API retrieval model learning system 220 may construct training data 2c using the original training data 2a and the converted training data 2b.

For example, when the original training data 2a is composed of {query (Q), API #1, API #2, . . . , API #N}, and the converted training data 2b is composed of [{a sub-query #1 of Q, API #1}, {a sub-query #2 of Q, API #2}, . . . , {a sub-query #N of Q, API #N}], the training data 2c may be composed of [Q, {a sub-query #1 of Q, API #1}, {a sub-query #2 of Q, API #2}, . . . , {a sub-query #N of Q, API #N}].

In another example, when a query index indicating a query included in the original training data 2a is i, a plurality of APIs related to the query Qᵢ is {Pᵢ_{₁}, . . . , Pᵢ_{_{d}}}, and a plurality of sub-queries included in the query Qᵢ corresponding to each of the plurality of APIs are {SQᵢ_{₁}, . . . , SQᵢ_{_{d}}}, the original training data 2a may be composed of (Qᵢ, {Pᵢ_{₁}, . . . , Pᵢ_{_{d}}}), the converted training data 2b may be composed of ({Pᵢ_{₁}, . . . , Pᵢ_{_{d}}}, {SQᵢ_{₁}, . . . , SQᵢ_{_{d}}}), and the training data 2c used for the supervised learning may be composed of (Qᵢ, {Pᵢ_{₁}, . . . , Pᵢ_{_{d}}}, {SQᵢ_{₁}, . . . , SQᵢ_{_{d}}}}).

In this case, {SQᵢ_{₁}, . . . , SQᵢ_{_{d}}} included in the training data 2c generated using the information output from the LLM 40 may be {SQᵢ_{₁}, . . . , SQᵢ_{_{d}}}=Ø. In other words, when the API retrieval model training system 220 converts the original data 2a using the output of the LLM 40, the query included in the original data 2a may not be divided into sub-queries, and thus the converted training data 2b in which the query is divided into a plurality of sub-queries may not be generated. In this case, only the query and the plurality of APIs related to the query may be included in the training data 2c.

In addition, the training data 2c may further include a retrieval score of each API based on the query included in the training data 2c.

The API retrieval model training system 220 may perform the steps/operations according to the embodiments described with reference to S100 to S300 to may construct a training data set including a plurality of training data respectively including different queries according to some embodiments of the present disclosure.

In S400, the API retrieval model 10 may be trained in the supervised manner using the training data 2c.

In S400, the API retrieval model learning system 220 may tokenize the query included in the training data 2c, and may generate a token embedding vector of each of tokens 21 included in the query using the query embedding model 20.

In S400, the API retrieval model learning system 220 may tokenize each of the sub-queries included in the training data 2c, and may generate a token embedding vector of each of tokens 21 included in the sub-query using the query embedding model 20.

In this regard, the sub-query is a partial text included in the query, and each of the tokens 21 included in the sub-query may correspond to each of the tokens 21 included in the query.

Further, in S400, the API retrieval model training system 220 may generate an API embedding vector of the API 32 corresponding to each sub-query included in the training data 2c using the API embedding model 30.

In S400, the API retrieval model training system 220 may train the API retrieval model 10 in the supervised manner using the training data 2c formed in the form of the embedding vector according to some embodiments of the present disclosure.

In S400, the API retrieval model training system 220 may perform the supervised learning of the API retrieval model 10 such that the API retrieval model 10 calculates a retrieval score of each API related to the query included in the training data 2c using a predefined loss function, thereby updating a parameter/weight of the API retrieval model 10.

In S400, the loss function used for the supervised learning of the API retrieval model 10 may be predefined using a difference between a retrieval score of the API related to the query and a retrieval score of the API related to each sub-query.

For example, when the API retrieval model 10 is trained in the supervised manner so as to calculate a retrieval score of each API related to a query included in the training data 2c using the training data set including a plurality of training data respectively including a plurality of different queries, the API retrieval model 10 may be trained in the supervised manner so as to minimize a value (i.e., loss) [symbol] of the loss function as defined as follows.

$${ℒ}_{total} = {ℒ}_{c e} + {λ}_{JS} * {ℒ}_{JS} + {λ}_{s q} * {ℒ}_{sq} ,$$

In this regard, each of λ_{JS} and λ_{sq} means a hyperparameter, [symbol] means cross entropy loss, [symbol] mean Jensen-Shannon (JS) loss, and [symbol] means sub-query loss.

When a vector set of token embedding vectors of the query Qᵢ included in the training data 2c is qᵢ, and the API embedding vector of each API Pᵢ_{ₓ} related to the query Qᵢ is Vᵢ_{ₓ}, the cross entropy loss [symbol] may be defined such that {Pᵢ_{₁}, . . . , Pᵢ_{_{d}}} related to the query Qᵢ is set to be of a positive class, and {Pⱼ_{₁}, . . . , Pⱼ_{ₜ}} related to the query Qⱼ of other training data included in the training data set may be set to be of a negative class so that the retrieval score s(qᵢ, vᵢ_{ₓ}) increases and the retrieval score s(qᵢ, vⱼ_{_{y}}) decreases.

The cross entropy loss is a value as an evaluation index to determine whether the API retrieval model 10 clearly distinguishes the positive class and the negative class from each other. According to some embodiments of the present disclosure, the API retrieval model 10 is trained such that the APIs related to the query of the training data 2c and the API unrelated thereto are classified into two different classes, the retrieval score s(qᵢ, vᵢ_{ₓ}) of the API classified to be of the positive class is calculated as a large value, and the retrieval score (qᵢ, vⱼ_{_{y}}) of the API classified to be of the negative class is calculated as a small value, thereby improving the performance of the API retrieval model 10.

When a vector set of token embedding vectors of the query Qᵢ included in the training data 2c is qᵢ, and the API embedding vector of each API Pir related to the query Qᵢ is Vᵢ_{ₓ}, the JS loss [symbol] may be defined as 1−2*(σ(JS(ms(qᵢ, vᵢ_{ₐ})∥ss(qᵢ, vᵢ_{_{b}})))−0.5) for (Pᵢ_{ₐ}, Pᵢ_{_{b}}).

When a vector set of token embedding vectors of the query Qᵢ included in the training data 2c is qᵢ, a sub-query included in the query Qᵢ is SQᵢ_{ₓ}, a vector set of token embedding vectors of each sub-query is sqᵢ_{ₓ}, and the API embedding vector of each API Pᵢ_{ₓ} related to the query Qᵢ and corresponding to each sub-query is Vᵢ_{ₓ}, the sub-query loss [symbol] may be defined as follows according to following two conditions.

If {SQᵢ_{₁}, . . . , SQᵢ_{_{d}}}=Ø, the sub-query loss [symbol] may be defined as 0.

If {SQᵢ_{₁}, . . . , SQᵢ_{_{d}}}≠Ø, the sub-query loss [symbol] may be defined as a sum of the cross entropy loss calculated by setting Pᵢ_{ₐ} for SQᵢ_{ₐ} to be of the positive class and the other Pᵢ_{_{b}} in {Pᵢ_{₁}, . . . , Pᵢ_{_{d}}} for SQᵢ_{ₐ} to be of the negative class and MSE(s(qᵢ, vᵢ_{ₐ}), s(sqᵢ_{ₐ}, vᵢ_{ₐ})) (MSE: Mean Squared Error).

The cross entropy loss of the sub-query loss [symbol] may allow the API retrieval model 10 to learn which sub-query among the sub-queries included in the query each of the APIs should match when the API retrieval model 10 is trained.

In addition, the MSE(s(qᵢ, vᵢ_{ₐ}), s(sqᵢ_{ₐ}, vᵢ_{ₐ}) of the sub-query loss [symbol] may cause the matching signal of each API and the query to be identical with the matching signal of each API and the sub-query when the API retrieval model 10 generates the matching signal.

According to some embodiments of the present disclosure, the API retrieval model 10 is trained in the supervised manner using the training data 2c composed of the sub-query included in the query and the API corresponding to the sub-query, and the API retrieval is performed using the API retrieval model 10 trained using supervised learning, so that the multi-step retrieval can be performed without dividing the query based on which the retrieval is performed into a plurality of sub-queries in the inference step of the API retrieval model 10.

Since the LLM 40 is not used in the inference step of the API retrieval model 10 and the multi-step retrieval can be performed even though the API retrieval model 10 does not perform several times of inferences on each sub-query, the resource consumption required for API retrieval may be reduced.

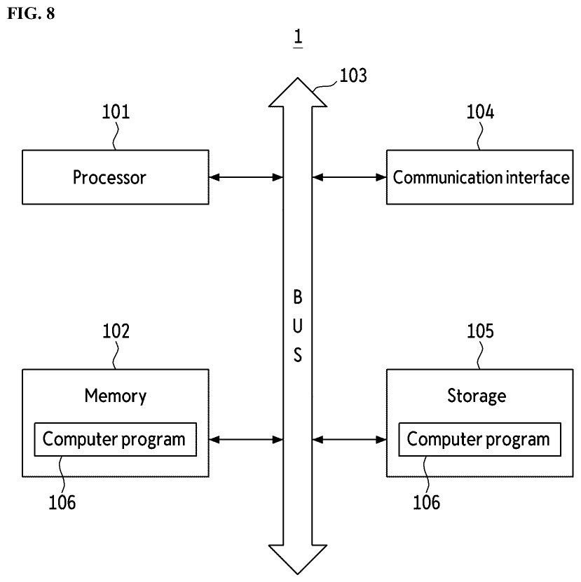

FIG. 8 is an illustrative hardware configuration diagram illustrating the computing device 160.

Referring to FIG. 8, the computing device 1 may include at least one processor 101, a system bus 103, a communication interface 104, a memory 102, which loads a computer program 106 executed by the processor 101, and a storage 105, which stores the computer program 106. Even though FIG. 8 depicts only components related to the embodiments of the present disclosure, it is obvious to one of ordinary skill in the art to which the present disclosure pertains that the computing device 1 may further include other generic components, in addition to the components depicted in FIG. 8. Moreover, in some embodiments, the computing device 1 may be configured with some of the components depicted in FIG. 8 omitted. The components of the computing device 1 will hereinafter be described.

The processor 101 may control the overall operation of each of the components of the computing device 1. The processor 101 may be configured to include at least one of a central processing unit (CPU), a micro-processor unit (MPU), a micro-controller unit (MCU), a graphics processing unit (GPU), Neural Processing Unit (NPU) or any form of processor well-known in the field of the present disclosure. Additionally, the processor 101 may perform computations for at least one application or program to execute operations/methods according to some embodiments of the present disclosure. The computing device 1 may be equipped with one or more processors.

The memory 102 may store various data, commands, and/or information. The memory 102 may load the computer program 166 from the storage 105 to execute the operations/methods according to some embodiments of the present disclosure. The memory 102 may be implemented as a volatile memory such as a random-access memory (RAM), but the present disclosure is not limited thereto.

The bus 103 may provide communication functionality between the components of the computing device 1. The bus 103 may be implemented in various forms such as an address bus, a data bus, and a control bus.

The communication interface 104 may support wired or wireless Internet communication of the computing device 1. Additionally, the communication interface 104 may also support various other communication methods. To this end, the communication interface 104 may be configured to include a communication module well-known in the technical field of the present disclosure.

The storage 105 may non-transitorily store at least one computer program 106. The storage 105 may be configured to include a non-volatile memory such as a read-only memory (ROM), an erasable programmable ROM (EPROM), an electrically erasable programmable ROM (EEPROM), a flash memory, as well as a computer-readable recording medium (e.g., non-transitory recording medium) in any form well-known in the technical field of the present disclosure, such as a hard disk or a removable disk.

The computer program 106, when loaded into the memory 102, may include one or more instructions that enable the processor 101 to perform the operations/methods according to some embodiments of the present disclosure. That is, by executing the loaded one or more instructions, the processor 101 may perform the operations/methods according to some embodiments of the present disclosure.

In the present disclosure, a computer-readable (non-volatile) storage medium can store at least one instruction or computer program, and at least one instruction or computer program, when executed by at least one processor, causes at least one processor to perform the methods and/or operations according to some embodiments of the present disclosure.

For example, the computer program 106 may include instructions for obtaining a first query; and inputting the first query to a pre-trained application programming interface (API) retrieval model, and determining a retrieval target API corresponding to the first query from among a plurality of candidate APIs, based on an output from the API retrieval model. In this regard, the API retrieval model is trained in a supervised manner using training data including a second query, an API set corresponding to the second query, and a sub-query corresponding to each of APIs included in the API set, wherein the sub-query may be composed of a partial text included in the second query.

In another example, the computer program 106 may include instructions for obtaining a query to be learned; identifying a plurality of sub-queries included in the query; constructing training data including the query, the plurality of sub-queries, and an application programming interface (API) corresponding to each of the plurality of sub-queries; and training the API retrieval model using the training data in a supervised manner.

According to some embodiments of the present disclosure, the retrieval target API corresponding to the query may be determined using the API retrieval model pre-trained using the training data composed of the sub-query included in the query and the API corresponding to the sub-query, thereby enabling the multi-step retrieval without dividing the query into sub-queries.

In addition, according to some embodiments of the present disclosure, in calculating the retrieval score of the candidate API for determination of the retrieval target API corresponding to the query from among the plurality of candidate APIs, the candidate API may be matched with the token included in the query.

Various embodiments of the present disclosure and their effects have been described so far with reference to FIGS. 1 through 8. The effects according to the technical idea of the present disclosure are not limited to those mentioned above, and other effects not discussed may be clearly understood by those skilled in the art from the following description.

The technical idea of the present disclosure described so far can be implemented as computer-readable code on a computer-readable medium. The computer program recorded on the computer-readable recording medium may be transmitted over a network, such as the Internet, to other computing devices where it can be installed and used.

Although operations are illustrated in a specific order in the drawings, it should not be understood that the operations need to be executed in the specific order shown or in sequential order, or that all illustrated operations need to be executed to obtain desired results. In certain circumstances, multitasking and parallel processing may be advantageous. In concluding the detailed description, those skilled in the art will appreciate that many variations and modifications may be made to the example embodiments without substantially departing from the principles of the present disclosure. Therefore, the disclosed example embodiments of the disclosure are used in a generic and descriptive sense only and not for purposes of limitation.

What is claimed is:

1. A method for retrieving an application programming interface (API), the method being performed by a computing system, the method comprising:
obtaining a first query; and
inputting the first query to a pre-trained API retrieval model, and determining a retrieval target API corresponding to the first query from among a plurality of candidate APIs, based on an output from the API retrieval model,
wherein the API retrieval model is trained using supervised learning with training data including a second query, an API set corresponding to the second query, and a sub-query corresponding to each of APIs included in the API set,
wherein the sub-query is composed of a partial text included in the second query.

2. The method of claim 1, wherein the first query includes a plurality of tokens,
wherein the API retrieval model includes:
a first layer configured to calculate a similarity between a candidate API included in the plurality of candidate APIs and each of the plurality of tokens; and
a second layer configured to calculate a retrieval score of the candidate API related to the first query, based on the similarity.

3. The method of claim 2, wherein the retrieval score of the candidate API is a sum of respective weights of the candidate API respectively related to the plurality of tokens included in the first query, wherein a weight of the respective weights is allocated based on the similarity.

4. The method of claim 3, wherein the plurality of tokens include a first token and a second token,
wherein when a first similarity between the candidate API and the first token is higher than a second similarity between the candidate API and the second token, a first weight of the candidate API related to the first token is higher than a second weight of the candidate API related to the second token.

5. A method for training an application programming interface (API) retrieval model, the method being performed by a computing system, the method comprising:
obtaining a query to be learned;
identifying a plurality of sub-queries included in the query;
constructing training data including the query, the plurality of sub-queries, and an API corresponding to each of the plurality of sub-queries; and
training the API retrieval model using supervised learning with the training data.

6. The method of claim 5, wherein the identifying of the plurality of sub-queries included in the query includes:
inputting the query into a large language model (LLM); and
determining the API corresponding to each of the plurality of sub-queries, based on information output from the LLM.

7. The method of claim 5, wherein the query includes a plurality of tokens,
wherein the API retrieval model includes:
a first layer configured to calculate a similarity between the API and each of the plurality of tokens; and
a second layer configured to calculate a retrieval score of the API related to the query, based on the similarity.

8. The method of claim 7, wherein the retrieval score of the API is a sum of respective weights of the API respectively related to the plurality of tokens included in the query, wherein a weight of the respective weights is allocated based on the similarity.

9. The method of claim 8, wherein the plurality of tokens include a first token and a second token,
wherein when a first similarity between the API and the first token is higher than a second similarity between the API and the second token, a first weight of the API related to the first token is higher than a second weight of the API related to the second token.

10. The method of claim 5, wherein the training of the API retrieval model using supervised learning with the training data includes:
training the API retrieval model in a supervised manner to calculate a retrieval score of the API related to the query using a loss function,
wherein the loss function is predefined using a difference between the retrieval score of the API related to the query and a retrieval score of the API related to a sub-query corresponding to the API.

11. A system for retrieving an application programming interface (API), the system comprising:
at least one processor; and
at least one memory storing instructions therein,
wherein when the instructions are executed by the at least one processor, the instructions cause the at least one processor to:
obtain a first query; and
input the first query to a pre-trained API retrieval model, and determine a retrieval target API corresponding to the first query from among a plurality of candidate APIs, based on an output from the API retrieval model,
wherein the API retrieval model is trained using supervised learning with training data including a second query, an API set corresponding to the second query, and a sub-query corresponding to each of APIs included in the API set,
wherein the sub-query is composed of a partial text included in the second query.

12. The system of claim 11, wherein the first query includes a plurality of tokens,
wherein the API retrieval model includes:
a first layer configured to calculate a similarity between a candidate API included in the plurality of candidate APIs and each of the plurality of tokens; and
a second layer configured to calculate a retrieval score of the candidate API related to the first query, based on the similarity.

13. The system of claim 12, wherein the retrieval score of the candidate API is a sum of respective weights of the candidate API respectively related to the plurality of tokens included in the first query, wherein a weight of the respective weights is allocated based on the similarity.

14. A system for training an application programming interface (API) retrieval model, the system comprising:
at least one processor; and
at least one memory storing instructions therein,
wherein when the instructions are executed by the at least one processor, the instructions cause the at least one processor to:
obtain a query to be learned;
identify a plurality of sub-queries included in the query;
construct training data including the query, the plurality of sub-queries, and an API corresponding to each of the plurality of sub-queries; and
train the API retrieval model using supervised learning with the training data.

15. The system of claim 14, wherein the identifying of the plurality of sub-queries included in the query includes:
inputting the query into a large language model (LLM); and
determining the API corresponding to each of the plurality of sub-queries, based on information output from the LLM.

16. The system of claim 14, wherein the query includes a plurality of tokens,
wherein the API retrieval model includes:
a first layer configured to calculate a similarity between the API and each of the plurality of tokens; and
a second layer configured to calculate a retrieval score of the API related to the query, based on the similarity.

17. The system of claim 16, wherein the retrieval score of the API is a sum of respective weights of the API respectively related to the plurality of tokens included in the query, wherein a weight of the respective weights is allocated based on the similarity.

18. The system of claim 14, wherein the training of the API retrieval model using supervised learning with the training data includes:
training the API retrieval model using supervised learning with to calculate a retrieval score of the API related to the query using a loss function,
wherein the loss function is predefined using a difference between the retrieval score of the API related to the query and a retrieval score of the API related to a sub-query corresponding to the API.

19. A non-transitory computer-readable storage medium storing a computer program, which, when executed by at least one processor, causes the at least one processor to perform:
obtaining a first query; and
inputting the first query to a pre-trained application programming interface (API) retrieval model, and determine a retrieval target API corresponding to the first query from among a plurality of candidate APIs, based on an output from the API retrieval model,
wherein the API retrieval model is trained using supervised learning with training data including a second query, an API set corresponding to the second query, and a sub-query corresponding to each of APIs included in the API set,
wherein the sub-query is composed of a partial text included in the second query.

20. A non-transitory computer-readable storage medium storing a computer program, which, when executed by at least one processor, causes the at least one processor to perform:
obtaining a query to be learned;
identifying a plurality of sub-queries included in the query;
constructing training data including the query, the plurality of sub-queries, and an application programming interface (API) corresponding to each of the plurality of sub-queries; and
training the API retrieval model using supervised learning with the training data.
